(19) United States
(12) Patent Application Publication
(10) Pub. No.: US 2009/0204498 A1
(43) Pub. Date: Aug. 13, 2009

(54) Government Targeted-Spending Stimulus Card System, Program Product, And Computer-Implemented Methods

(76) Inventor: Scott Galit, New York, NY (US)

Correspondence Address: BRACEWELL & GIULIANI LLP, P.O. BOX 61389, HOUSTON, TX, 77208-1389, US

(21) Appl. No.: 12/367,187

(22) Filed: Feb. 6, 2009

Related U.S. Application Data
(60) Provisional application No. 61/027,270, filed on Feb. 8, 2008.

(51) Int. Cl. G06Q 20/00; G06Q 10/00; G06Q 40/00; G06Q 30/00; G06Q 50/00

(52) U.S. Cl. 705/14; 705/41; 705/30; 705/1

(57) ABSTRACT

Embodiments of the present invention, for example, provide a government stimulus card being issued and managed by a bank and using an open payment network for purchase authorization and payments. The embodiments provide flexibility in the funding of stimulus programs, including no upfront payments by the government and letters of credit from third-party lenders, permitting the government to retain funds until the spending occurs by cardholders. Embodiments provide targeted-spending stimulus by excluding cash payments to consumers, by limiting usage of the card to only targeted merchants, by requiring reports from the bank that document consumer purchases using the stimulus card, and by establishing relationships with merchants to provide a discount for using the stimulus card as payment, advantageously resulting in a greater effect to the economy from government targeted-spending stimulus program. Embodiments also include funding a promotion card on behalf of an entity as part of a promotion program.

### RELATED APPLICATIONS

This application claims priority to and the benefit of U.S. Provisional Patent Application No. 61/027,270, titled “Government Targeted-Spending Stimulus Card System, Program Product, and Associated Methods”, filed on Feb. 8, 2008, incorporated herein by reference in its entirety. This application also relates to: U.S. Provisional Patent Application No. 61/014,950, titled “Private Label Promotion Card System, Program Product, and Associated Methods”, filed on Dec. 19, 2007; U.S. patent application Ser. No. 12/338,497, by Galit, titled “Private Label Promotion Card System, Program Product, and Associated Computer-Implemented Methods”, filed Dec. 18, 2008; U.S. patent application Ser. No. 12/338,540, by Galit, titled “Private Label Promotion Card System, Program Product, and Associated Computer-Implemented Methods”, filed Dec. 18, 2008; each of which is incorporated herein by reference in its entirety.

### BACKGROUND

1. Field of Invention

The present invention relates generally to the financial service and card product industries, and, more particularly, to systems, computer program products, and computer-implemented methods of providing governmental rebates and economic stimulus payments.

2. Background

Governments or government entities currently offer tax rebates, distributions associated with a traditional economic stimulus programs, and other similar payments by mailing checks to consumers.

For governments, there are a number of challenges that limit the effectiveness of check-based payments intended to stimulate the economy. First, the government has limited ability to ensure the funds are used to actually make purchases. Second, the government must make a payment of all the funds to the consumer once the check is deposited, not when the money is spent. In addition, the government has no data that indicates when and where the funds enter the economy, limiting the ability to measure the impact of the stimulus.

For example, although a government may decide that it is necessary to stimulate the economy and plan to distribute as much as $150 billion, it is widely acknowledged that only a portion of funds distributed will actually be spent stimulating the economy.

### SUMMARY OF INVENTION

Applicant has recognized that in a traditional economic stimulus program, there is limited ability to know precisely When, where, and how much of the stimulus funds gets spent. In view of the above, Applicant provides embodiments of a government targeted-spending stimulus card system, program product, and computer-implemented methods. Accordingly, embodiments of the present invention provide a government targeted-spending stimulus card associated with a government targeted-spending stimulus program being offered on behalf of the government by a bank, for example, a federally-chartered bank or a state-chartered bank, and subject to government banking laws and regulations. The bank product, according to embodiments of the present invention, has numerous other features and benefits as understood by those skilled in the art, including being issued and managed by a bank; using the existing point-of-sale (POS) infrastructure and an open payment network, e.g., VISA, MasterCard, Discover, and American Express, for purchase authorization and payments, rather than a proprietary or in-house system; and employing a compelling, easy-to-use consumer package.

Rather than issuing checks to consumers under a government targeted-spending stimulus program, embodiments of the present invention provide for the delivering a stimulus card to consumers, which has numerous features and benefits. For example, there are significant costs for handling paper rebates and checks, as understood by those skilled in the art. Moreover, embodiments of the present invention provide financing options to thereby enable the government offering the stimulus card to delay funding the bank until the consumer accesses the value on the stimulus card. For example, when a government issues a stimulus check to a consumer today, funds for a given check are debited from the government account all at once as a function of the check being deposited by the consumer, necessarily prior to the consumer having access to the funds. When a government issues a stimulus card according to an embodiment of the present invention, however, funds are advantageously debited piecemeal from the government account as the value associated with the stimulus card is spent by the consumer. The funds can either be deposited by the government with the bank, or the bank can let funds stay with the government and request funds as required for settlement, as understood by those skilled in the art. This feature allows the government to distribute, for example, $150 billion in stimulus without actually transferring the funds out of the government treasury, as understood by those skilled in the art. Therefore, embodiments of the present invention keep funds in the government treasury longer, as understood by those skilled in the art. In addition, the embodiments of the present invention can also employ a bank-extended line of credit or a letter of credit from a third-party lender, whether arranged by the government or by the bank, guaranteeing payment to the bank for the, for example, $150 billion in stimulus, by the third-party lender in the event of non-payment by the government, as understood by those skilled in the art.

Moreover, according to embodiments of the present invention, the bank can create reports for the government, for example, that document the consumer purchases using the stimulus card, in detail or in aggregate. The reports, according to an embodiment of the present invention, advantageously can provide the government with actual data rather than conjecture as to the effects of the economic stimulus program, as understood by those skilled in the art, Knowing where and when stimulus funds are spent offers the government the ability to target spending, perhaps saving billions of dollars of unnecessary spending in a target-spending stimulus program.

Another feature of the embodiments of the present invention is the ability for the government to target spending. For example, the government targeted-spending stimulus program, according to embodiments of the present invention, includes a selection of a plurality of targeted merchants as eligible to receive the payments on behalf of the consumer. Alternately, the government targeted-spending stimulus program can exclude certain merchants or certain merchant categories, according to embodiments of the present invention. Thus, according to an embodiment of the present invention, the government can advantageously prevent consumers from using the funds for purposes the government prefers not to fund and, for example, can exclude stimulus card purchases involving casinos, sexually-related businesses, and medical marijuana distributors according to another embodiment of the present invention. In a different example, if one segment of the economy is booming and struggling to keep up with demand, while the government desires to stimulate a second segment of the economy, the government targeted-spending stimulus program, according to embodiments of the present invention, can include in the selection of the plurality of targeted merchants as eligible to receive the payments on behalf of the consumer only those merchants in the second segment of the economy, which the government desires to stimulate.

A further benefit of issuing a consumer a stimulus card associated with a value, according to embodiments of the present invention, for example, is the assurance that all funds directly stimulate the economy, including increasing purchases of goods and services. That is, embodiments of the present invention provide for the exclusion of cash payments on behalf of the consumer to prevent the consumer access to cash under the government targeted-spending stimulus program. Therefore, rather than the consumer merely depositing the funds into the consumer's bank account, under embodiments of the present invention a consumer must make a purchase to access the value on the stimulus card, perhaps savings the government billions in unnecessary distributions.

In addition, the bank can establish a relationship with the merchants to provide a discount for a consumer purchase using the stimulus card as payment. As part of a government targeted-spending stimulus program according to an embodiment of the present invention, this relationship and its associated discount can advantageously result in a greater effect to the economy from economic stimulus package.

Moreover, the stimulus card, according to embodiment of the present invention, includes an expiration date, as understood by those skilled in the art. Thus, the government can target the timeframe and duration of the targeted-spending stimulus program, according to embodiments of the present invention, perhaps saving billions in unnecessary spending.

Embodiments of the present invention include a computer-implemented method of funding a government targeted-spending card. The computer-implemented method includes initiating a targeted-spending stimulus program on behalf of a government with a targeted-spending stimulus card by a bank computer. According to embodiments of the present invention, the stimulus program includes authorization of payments from government funds on behalf of a consumer up to a pre-selected spending limit, a selection of a plurality of targeted merchants as eligible to receive the payments on behalf of the consumer, and exclusion of cash payments on behalf of the consumer to thereby prevent the consumer access to cash. The method continues with delivering to the consumer the government targeted-spending stimulus card and activating the card by the bank computer. According to embodiments of the present invention, the stimulus card is from a bank and subject to government banking laws and regulations; in addition, the stimulus card is configured for authorization for a value of the pre-selected spending limit associated with the government targeted-spending stimulus program. The computer-implemented method also includes the bank computer determining whether a proposed purchase by the consumer is less than an amount of funds remaining for the stimulus card up to the pre-selected spending limit and whether the proposed consumer purchase is requested from one of the plurality of targeted merchants, to thereby authorize consumer spending from the stimulus card with the one of the plurality of targeted merchants. For purposes of this application, determining whether a proposed purchase is less than an amount includes whether the proposed purchase is “less than or equal to” the amount. The computer-implemented method further includes requesting the funds from a government computer by the bank computer responsive to the authorized consumer spending from the stimulus card with the one of the plurality of targeted merchants to thereby fund the stimulus card. According to embodiments of the present invention, the funds can be no more than the pre-selected spending limit. Advantageously, the method allows for the funds to remain in the government treasury longer than previous solutions.

In addition, embodiments of the present invention provide, for example, a system for finding a government targeted-spending stimulus card. The system can include a first computer associated with a bank defining a bank computer and a second computer associated with a government defining a government computer in communication with the first computer. The bank computer can, for example, manage an account associated with the government stimulus cards as part of a government targeted-spending stimulus program. The system can also include a plurality of point-of-sale terminals, each associated with one of the plurality of targeted merchants and having a processor, defining an acquiring processor. The system can further include an open payment network in communication with the bank computer and each acquiring processor. The open payment network can receive a proposed consumer purchase request using one or more government stimulus cards as payment as captured by the acquiring processor of the point of sale terminal, receive an authorization response from the bank computer, transfer funds from the open payment network to one of the plurality of targeted merchants in response to an authorized consumer purchase using the government stimulus card as payment, and request funds from the bank computer to satisfy the authorized consumer purchase using government stimulus card as payment. The system can include a third computer associated with a third-party lender, defining a third-party lender computer, to provide a letter of credit to the bank on behalf of the government and to provide funds under the letter of credit responsive to non-payment by the government. The system can also include a computer program product associated with the bank computer, as discussed below.

Embodiments of the present invention can further include a computer program product associated with the bank computer, stored on a tangible computer memory media, and operable on a computer, the computer program product including a set of instructions that, when executed by the computer, cause the computer to perform various operations. The operations can include initiating the targeted-spending stimulus program on behalf of a government with the government stimulus card and delivering to the consumer the government targeted-spending stimulus card. The operations can include the bank computer activating the government targeted-spending stimulus card. The operations can also include determining by the bank computer whether the proposed purchase by the consumer is less than an amount of funds remaining for the government stimulus card up to the pre-selected spending limit and whether the proposed consumer purchase is requested from one of the plurality of targeted merchants to thereby authorize consumer targeted-spending from the government stimulus card with the one of the plurality of targeted merchants. The operations can further include requesting the funds from a government computer by the bank computer responsive to the authorized consumer spending from the stimulus card.

In addition, embodiments of the present invention include systems, program products, and computer-implemented methods of providing stimulus cards on behalf of a government and promotion cards on behalf of an entity as will be understood by those skilled in the art.

### BRIEF DESCRIPTION OF DRAWINGS

So that the manner in which the features and benefits of the invention, as well as others which will become apparent, may be understood in more detail, a more particular description of the invention briefly summarized above may be had by reference to the embodiments thereof which are illustrated in the appended drawings, which form a part of this specification. It is also to be noted, however, that the drawings illustrate only various embodiments of the invention and are therefore not to be considered limiting of the invention's scope as it may include other effective embodiments as well.

FIG. 1 is a schematic flow diagram of a computer-implemented method of funding a government targeted-spending stimulus card according to an embodiment of the present invention;

FIG. 2 is a decision flowchart according to an embodiment of the present invention;

FIG. 3 is a partial schematic block diagram of a computer program product according to an embodiment of the present invention;

FIG. 4 is a schematic block diagram of a system to fund a government targeted-spending stimulus card according to an embodiment of the present invention;

FIGS. 5A and 5B are respective front and rear views of a government targeted-spending stimulus card according to an embodiments of the present invention;

FIG. 6 is a schematic block diagram of a system to provide promotion cards on behalf of an entity according to an embodiment of the present invention;

FIG. 7 is a schematic flow diagram of a computer-implemented method of funding a promotion card according to an embodiment of the present invention;

FIG. 8 is a front plan view of a display screen of a computer displaying an excerpt of transaction history statement according to an embodiment of the present invention;

FIG. 9 is a front plan view of a display screen of a access interface device displaying a text message of an account balance according to an embodiment of the present invention;

FIG. 10 is a front plan view of a display screen of a computer displaying a visual depiction of stimulus spending as a function of time according to an embodiment of the present invention;

FIG. 11 is a front plan view of a display screen of a computer displaying a visual depiction of stimulus spending as a function of merchant category according to an embodiment of the present invention;

FIG. 12 is a front plan view of a display screen of a computer displaying a visual depiction of stimulus spending as a function of location according to an embodiment of the present invention;

FIG. 13 is a schematic block diagram of a system to fund a government targeted-spending stimulus card according to an embodiment of the present invention; and

FIG. 14 is a schematic block diagram illustrating an exemplary database construction according to an embodiment of the present invention.

### DETAILED DESCRIPTION

The present invention will now be described more fully hereinafter with reference to the accompanying drawings, which illustrate embodiments of the invention. This invention may, however, be embodied in many different forms and should not be construed as limited to the illustrated embodiments set forth herein; rather, these embodiments are provided so that this disclosure will be thorough and complete, and will fully convey the scope of the invention to those skilled in the art. Like numbers refer to like elements throughout.

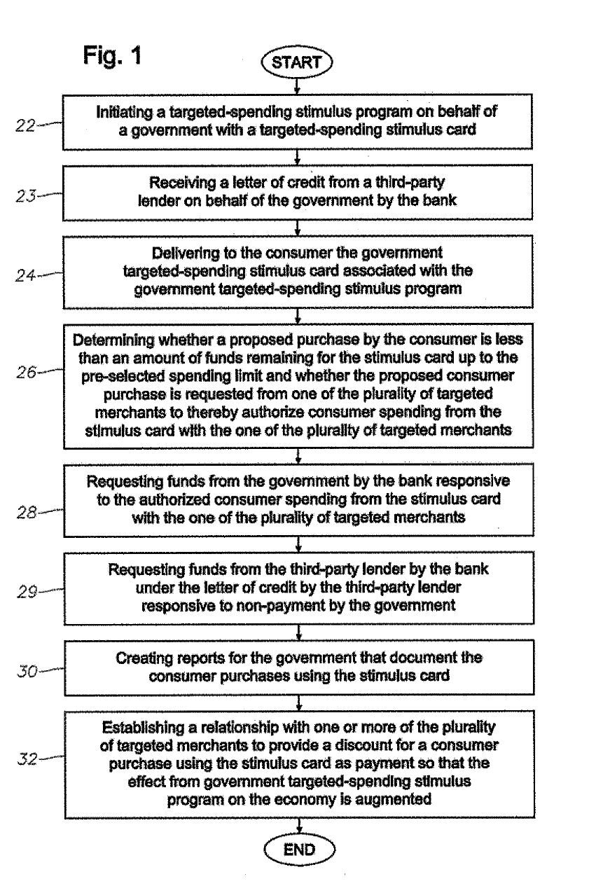

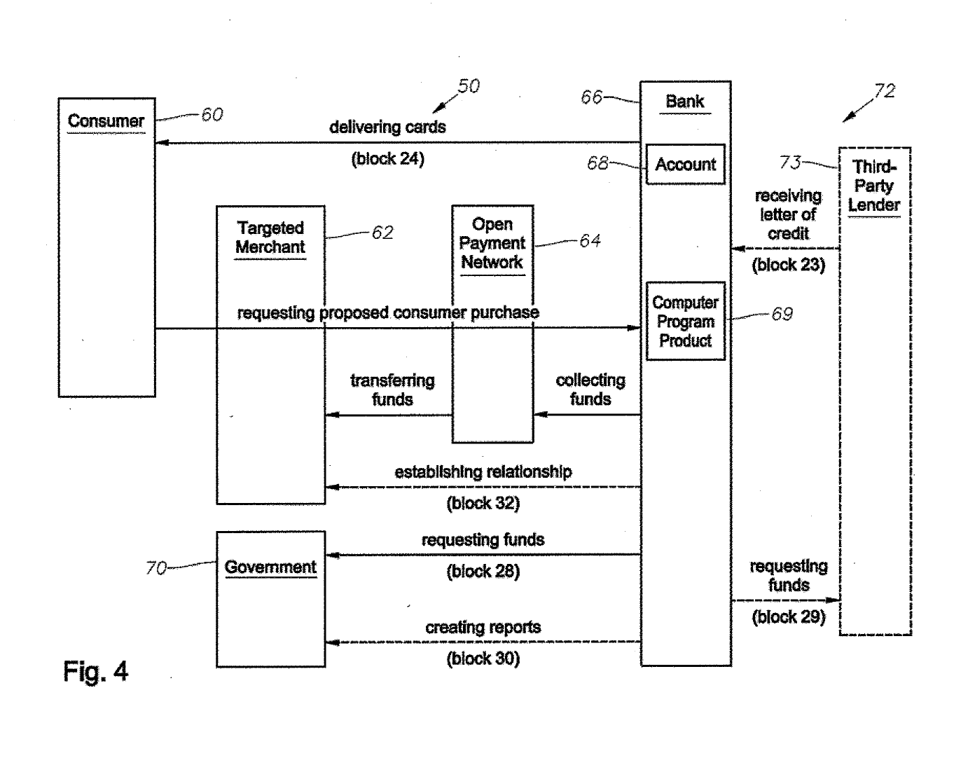

Features of the embodiments of the present invention include the assurance that all funds spent directly stimulate the economy. As part of a government targeted-spending stimulus program according to an embodiment of the present invention, as illustrated in FIGS. 1, 4, and 6, the government 70 can advantageously prevent consumers 60 from using the funds to access cash via ATM or otherwise, as understood by those skilled in the art. Rather than the consumer 60 merely depositing the funds into the consumer's bank account, under embodiments of the present invention a consumer 60 must make a purchase with one of a plurality targeted merchants 62 to access the value on the stimulus card 50, perhaps savings the government billions in unnecessary distributions in order to achieve the desired stimulus.

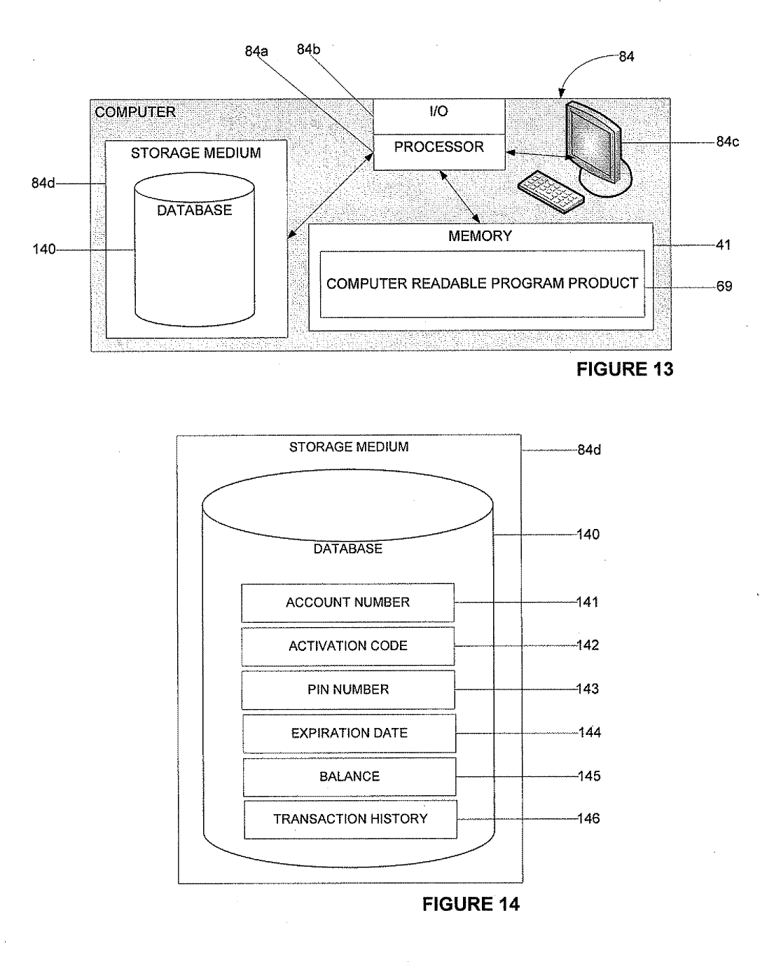

Another feature of the embodiments of the present invention, as illustrated in FIGS. 1, 4, 6, 13, and 14, include and the ability for the government to target spending. The government targeted-spending stimulus program, according to embodiments of the present invention, includes, for example, a selection of a plurality of targeted merchants 62 as eligible to receive the payments on behalf of the consumer 60. Alternately, the government targeted-spending stimulus program can exclude certain merchants or certain merchant categories, according to embodiments of the present invention. Thus, the government 70 can advantageously prevent consumers 60 from using the funds for purposes the government prefers not to fund and, for example, can exclude stimulus card purchases involving casinos, sexually-related businesses, and medical marijuana distributors according to another embodiment of the present invention. In a different example, if one segment of the economy is booming and struggling to keep up with demand, while the government 70 desires to stimulate a second segment of the economy, the government targeted-spending stimulus program, according to embodiments of the present invention, can include in the selection of the plurality of targeted merchants 62 as eligible to receive the payments on behalf of the consumer only those merchants in the second segment of the economy, which the government desires to stimulate.

Yet another feature of the embodiments of the present invention, as illustrated in FIGS. 1, 3, and 4, provides financing options to thereby enable the government 70 offering the stimulus card 50 to delay funding the bank 66 until the consumer 60 accesses the value on the stimulus card 50. For example, when a government 70 issues a stimulus check to a consumer today, funds for a given check are debited from the government account all at once as a function of the check being deposited by the consumer, necessarily prior to the consumer 60 having access to the funds. When a government 70 issues a stimulus card 50 according to an embodiment of the present invention, however, funds are advantageously debited piecemeal from the government account 68 as the value associated with the stimulus card is spent by the consumer 60. According to an embodiment of the present invention, government funds can be deposited with the bank in, for example, a government account, as understood by those skilled in the art. According to another embodiment of the present invention, the government funds remain with the government 70 and not in an account at the bank, and the bank requests funds from the government as required for settlement (block 28). This feature, as understood by those skilled in the art, allows the government 70 to distribute, for example, $150 billion in stimulus without actually transferring the funds out of the government treasury. In yet another embodiment of the present invention, a third-party lender 73 can provide a letter of credit on behalf of the government 70, whether arranged by the government 70 or by the bank 66, as understood by those skilled in the art, so that the bank 66 is guaranteed payment for the, for example, $150 billion in stimulus, by the third-party lender 73 in the event of non-payment by the government 70. Therefore, embodiments of the present invention keep funds in the government treasury longer, as understood by those skilled in the art.

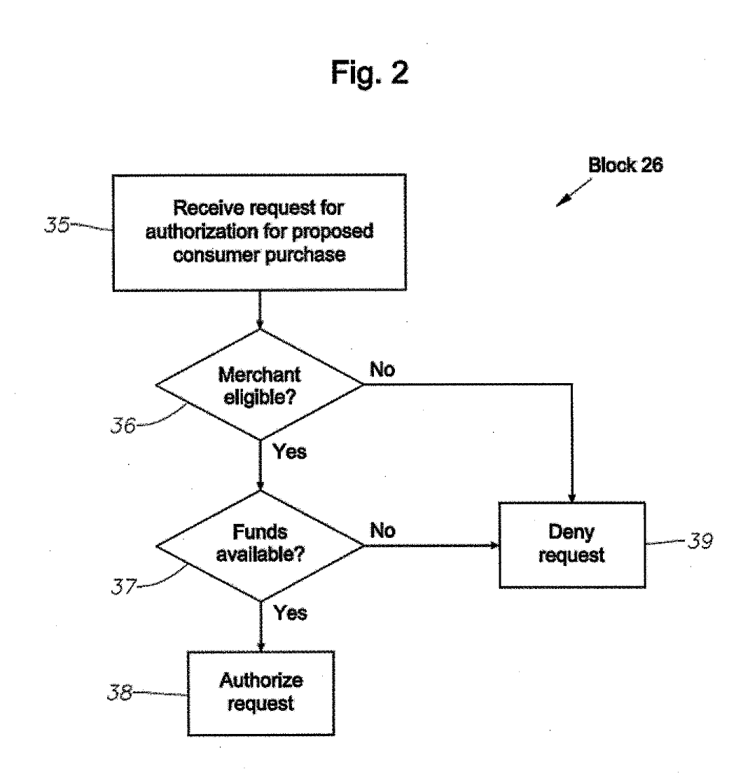

As illustrated in FIG. 1, embodiments of the present invention include a computer-implemented method of funding a government targeted-spending stimulus card. The method can include a bank computer 84 initiating a targeted-spending stimulus program on behalf of a government with a targeted-spending stimulus card (block 22). A government targeted-spending stimulus package, as will be understood by those skilled in the art, is a public policy tool for getting extra money into the economy and generating consumer spending. It will be understood by those skilled in the art, however, that other types of policies including a tax rebate can be used as well that emulate or act as type of government economic stimulus package or accomplish similar purposes to the government economic stimulus package. According to embodiments of the present invention, the stimulus program includes authorization of payments from government funds on behalf of a consumer up to a pre-selected spending limit, a selection of a plurality of targeted merchants 62 as eligible to receive the payments on behalf of the consumer 60, and exclusion of cash payments on behalf of the consumer to thereby prevent the consumer access to cash. The computer-implemented method can include receiving a letter of credit from a third-party lender 73 on behalf of the government 70 by a bank 66 (block 23). The computer-implemented method can continue with delivering to the consumer the government targeted-spending stimulus card (block 24) and activating the card 50 by the bank computer 84 to thereby convert an inactivated card into an activated card having an associated value and being capable of purchasing goods, services, or goods and services. The bank computer 84 can activate the stimulus card 50 by, for example, modifying a field in an entry in a database 140 stored on the bank computer 84, where the entry is associated with the stimulus card. As part of a proposed transaction, the computer program product 69 can read the field in an entry in a database 140 stored on the bank computer to confirm the status of the stimulus card as activated. According to embodiments of the present invention, the stimulus card 50 is from a bank 66 and subject to government banking laws and regulations; in addition, the stimulus card 50 is configured for authorization for a value of the pre-selected spending limit associated with the government targeted-spending stimulus program The computer-implemented method further includes the bank computer 84 determining whether a proposed purchase by the consumer 60 is less than an amount of funds remaining for the stimulus card up to the pre-selected spending limit and whether the proposed consumer purchase is requested from one of the plurality of targeted merchants, to thereby authorize consumer spending from the stimulus card with the one of the plurality of targeted merchants (block 26), as further illustrated in FIG. 2. The computer-implemented method can also include requesting the funds from the government computer 70 by the bank 66 responsive to the authorized consumer spending from the stimulus card 50 with the one of the plurality of targeted merchants 62 to thereby fund the stimulus card 50 (block 28). According to embodiments of the present invention, the funds can be no more than the pre-selected spending limit. Advantageously, the computer-implemented method can allow for the funds to remain in the government treasury longer than previous solutions.

According to embodiments of the present invention, the computer-implemented method can further include requesting funds from the third-party lender 73 by the bank under the letter of credit by the third-party lender responsive to non-payment by the government (block 29). For example, the letter of credit, as will be understood by those skilled in the art, is a technique or tool that guarantees the bank issuing the stimulus card that should the government default or delay payment, the bank that provides the letter of credit will provide the funds. In an embodiment, for example, it would be expected that the government continues to make the payments to fund the spending. The letter of credit can be a way to allow the government to defer the funding because there is a third party guaranteeing the government funding. It will be understood by those skilled in the art, however, that other types of guarantees can be used as well that emulate or act as type of letter of credit or accomplish similar purposes to the letter of credit. This feature, according to embodiments of the present invention, whether arranged by the government or by the bank, allows the government to distribute, for example, $150 billion in stimulus without actually transferring the funds out of the government treasury, as understood by those skilled in the art.

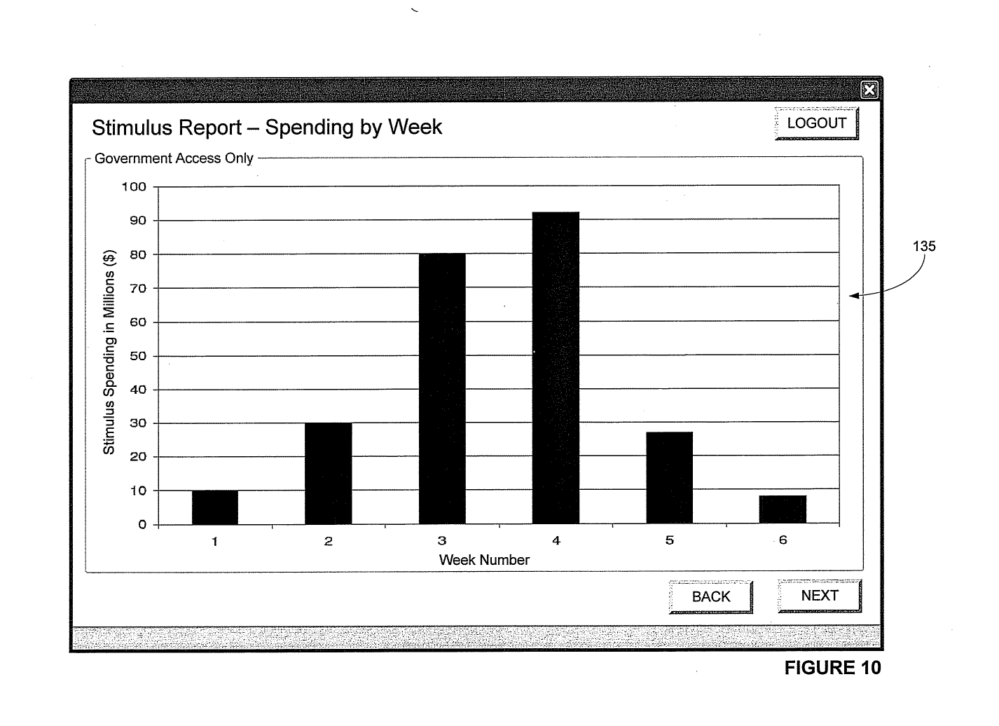

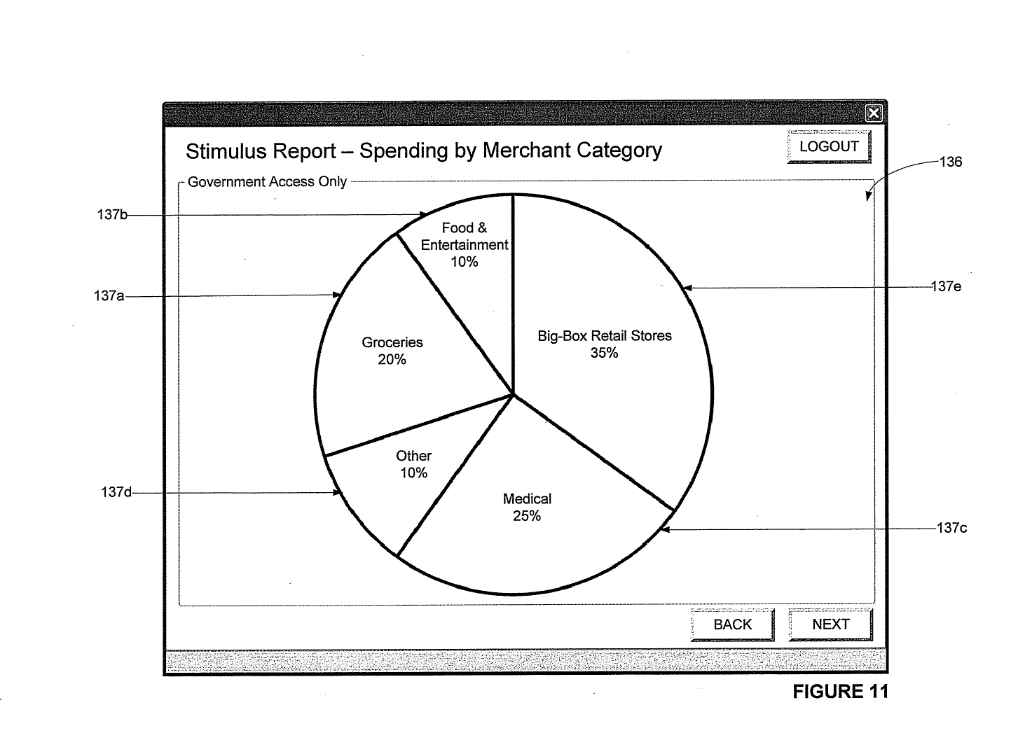

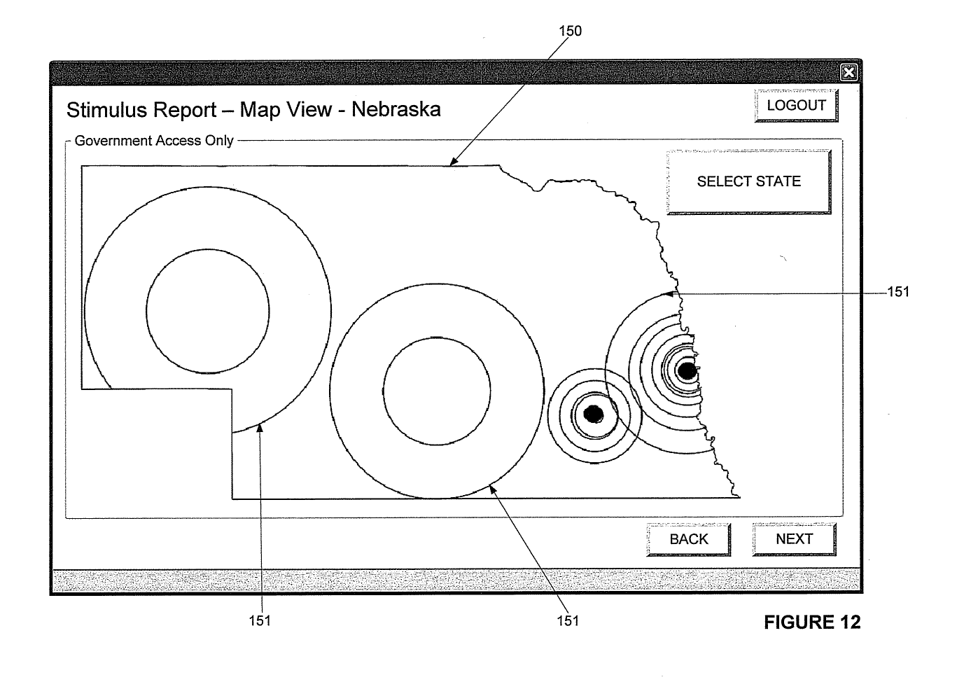

The computer-implemented method can further include creating reports for the government that document the consumer purchases using the stimulus card so that the government targeted-spending stimulus program receives actual data on when and where the stimulus funds are spent (block 30). As illustrated in FIGS. 10-12, the reports, according to an embodiment of the present invention, advantageously can provide the government with actual data, in detail or in aggregate, rather than conjecture as to the effects of the economic stimulus program, as understood by those skilled in the art. Knowing where and when stimulus funds are spent offers the government the ability to target spending, perhaps saving billions of dollars of unnecessary spending in a target-spending stimulus program. As illustrated in FIG. 12, the reports can provide, for example, a visual depiction of the spending due to the stimulus program as a function of location 150 (i.e., a contour map using contour lines 151 to indicate stimulus program spending levels, a heat map using colors to indicate stimulus program spending levels, or other such depiction) so that the relative effect of the stimulus program on a particular region, state, or city is apparent. For each transaction, the location may be determined by the address of the merchant so that, as understood by those skilled in the art, aggregated transaction data can be populated onto a map to indicate a number of transactions, a cumulative amount of stimulus spending associated with various transactions at a location, or other metric of the effect of the stimulus program. As illustrated in FIG. 10, the reports can also provide, for example, a visual depiction of spending due to the stimulus program as a function of time 135 so that future economic stimulus programs can be more narrowly tailored by the government to achieve a desired result. If stimulus funds are typically spent several months after being made available to a consumer, the policy goals of an economic stimulus package may be undermined. If, however, stimulus funds are typically spent relatively quickly after being made available to a consumer, the government may be able to achieve the desired result with a shorter and smaller stimulus program. As illustrated in FIG. 11, the reports can also provide, for example, a graphical representation 136 of spending due to the stimulus program by merchant category 137a-137e to thereby facilitate analysis of the economic stimulus program. A visual depiction that, for example, relatively more funds from the economic stimulus program are being spent on medical care 137c than entertainment 137b, including movies, concerts, and sporting events, can transform a traditional blunt stimulus program into a focused public policy tool. Advantageously, these visual depiction embodiments can convert stimulus behavior into identifiable spending patterns.

In addition, the computer-implemented method can include establishing a relationship with one or more of the plurality of targeted merchants to provide a discount for a consumer purchase using the stimulus card as payment so that the effect from government targeted-spending stimulus program on the economy is augmented (block 32). As an example, a merchant could normally pay 3% (for illustration purposes) to a bank for payments using a credit or prepaid card through an open payment network. A relationship, according to embodiments of the present invention, can result in the merchant paying 2% (for illustration purposes) to the bank for payments the government stimulus card and offering consumers an additional 1% on all purchases using the government stimulus card as payment, augmenting the effect from the government targeted-spending stimulus program on the economy.

The computer-implemented method is flexible with respect to activation of the stimulus cards. The computer-implemented method can include activating the stimulus card 50 by the bank 66 by the bank computer 84 through an electronic communications network 74 after delivering the cards to the consumer to thereby convert an inactivated card into an activated card having an associated value and being capable of purchasing goods, according to embodiments of the present invention. In an exemplary embodiment, an inactive government targeted-spending card is delivered to the consumer by postal service. As understood by those skilled in the art, the electronic communications network 74 can include a global communications network, an Automated Clearing House network, and a network responsive to an interactive voice response unit. Alternately, the computer-implemented method can include activating the stimulus card 50 by the bank 66 by the bank computer 84 prior to delivery to the consumer 60.

As illustrated in FIGS. 1, 4, 5, 6, 13, and 14, embodiments of the present invention provide, for example, a system 72 for funding a government targeted-spending stimulus card 50. The system 72 can include a first computer associated with a bank 66 defining a bank computer 84 and a second computer associated with a government 70 defining a government computer 80 in communication with the first computer 84. The bank computer 84 can include, for example, one or more processors 84a, input and output devices 84b, displays 84c, memory 41, and storage media 84d. The bank computer can include, for example, a database 140; information in the database 140 can include, for example, an account number 141 (which can be matched to an account number 54 on a card 50), an activation code 142, a PIN number 143, an expiration date 144 (which typically matches an expiration date 56 on a card 50), a balance 145, and records of transaction history 146. The bank computer 84 manages an account 68 associated with the government stimulus cards. 50 as part of a government targeted-spending stimulus program, including, for example, call center and fraud management, as understood by those skilled in the art. As understood by those skilled in the art, the government targeted-spending stimulus program involves the delivery of a stimulus card 50 to consumer 60 (block 24) to thereby stimulate consumer purchases. The system 72 also includes a plurality of point-of-sale terminals 82, each associated with one of the plurality of targeted merchants 62 and having a processor, defining an acquiring processor 86. The system 72 further includes an open payment network 64, e.g., VISA, MasterCard, Discover, and American Express, as understood by those skilled in the art, in communication with the bank computer 84 and each acquiring processor 86. The open payment network 64 receives a proposed consumer purchase request using one or more government stimulus cards 50 as payment as captured by the acquiring processor 86 of the point of sale terminal 82, receives an authorization response from the bank computer 84, transfers funds from the open payment network 64 to one of the plurality of targeted merchants 62 in response to an authorized consumer purchase using the government stimulus card 50 as payment, and collects funds from the bank 66 to satisfy the authorized consumer purchase using government stimulus card 50 as payment. The system 72 can include a third computer associated with a third-party lender 73, defining a third-party lender computer, to provide a letter of credit to be received by the bank 66 on behalf of the government 70 (block 23) and to provide funds requested by the bank 66 under the letter of credit responsive to non-payment by the government 70 (block 29). The system also includes a computer program product 69 associated with the bank computer, as discussed below.

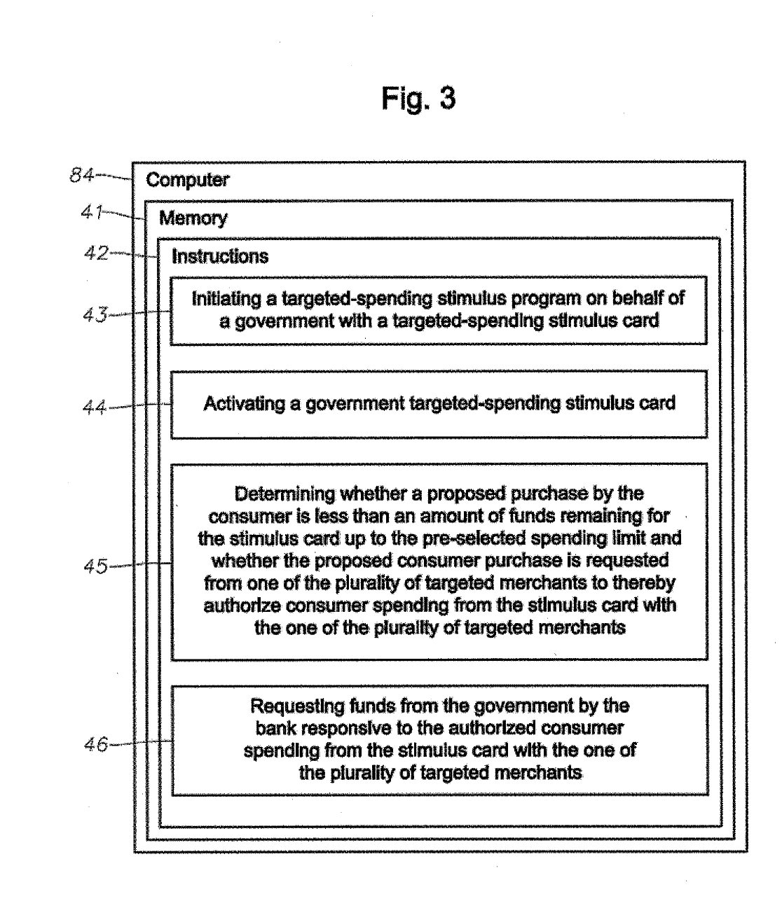

Embodiments of the present invention further include, as illustrated in FIG. 3, a computer program product 69 associated with the bank computer 84, stored on a tangible computer memory media 41, and operable on a computer, the computer program product 69 comprising a set of instructions 42 that, when executed by the computer 84, cause the computer 84 to perform various operations. The operations can include initiating the targeted-spending stimulus program on behalf of a government with the government stimulus card (block 43) and activating the government targeted-spending stimulus card (block 44) by the bank computer 84. The operations can also include the bank computer 84 determining whether the proposed purchase by the consumer is less than an amount of funds remaining for the government stimulus card up to the pre-selected spending limit and whether the proposed consumer purchase is requested from one of the plurality of targeted merchants to thereby authorize consumer targeted-spending from the government stimulus card with the one of the plurality of targeted merchants (block 45). See also FIG. 2. The operations further include requesting the funds from the government by the bark computer 84 responsive to the authorized consumer spending from the stimulus card 50 (block 46).

A person having ordinary skill in the art will recognize that various types of memory are readable by a computer such as described herein, e.g., government computer, bank computer, computer server, open payment network processors, or other computers within embodiments of the present invention. Examples of computer readable media include but are not limited to: nonvolatile, hard-coded type media such as read only memories (ROMs), CD-ROMs, and DVD-ROMs, or erasable, electrically programmable read only memories (EEPROMs), recordable type media such as floppy disks, hard disk drives, CD-R/RWs, DVD-RAMs, DVD-R/RWs, DVD+R/RWs, flash drives, memory sticks, and other newer types of memories, and transmission type media such as digital and analog communication links. For example, such media can include operating instructions, as well as instructions related to the system and the method steps described above and can operate on a computer. It will be understood by those skilled in the art that such media can be at other locations instead of or in addition to the locations described to store program products, e.g., including software, thereon. Embodiments of a system, for example, can include a plurality of merchant point-of-sale interfaces as illustrated and described herein and one or more remote computer servers positioned to provide communication with each of the plurality of merchant point-of-sale interfaces and being associated with a financial institution. Each of these computer servers, for example, can having one or more of these various types of memory as understood by those skilled in the art.

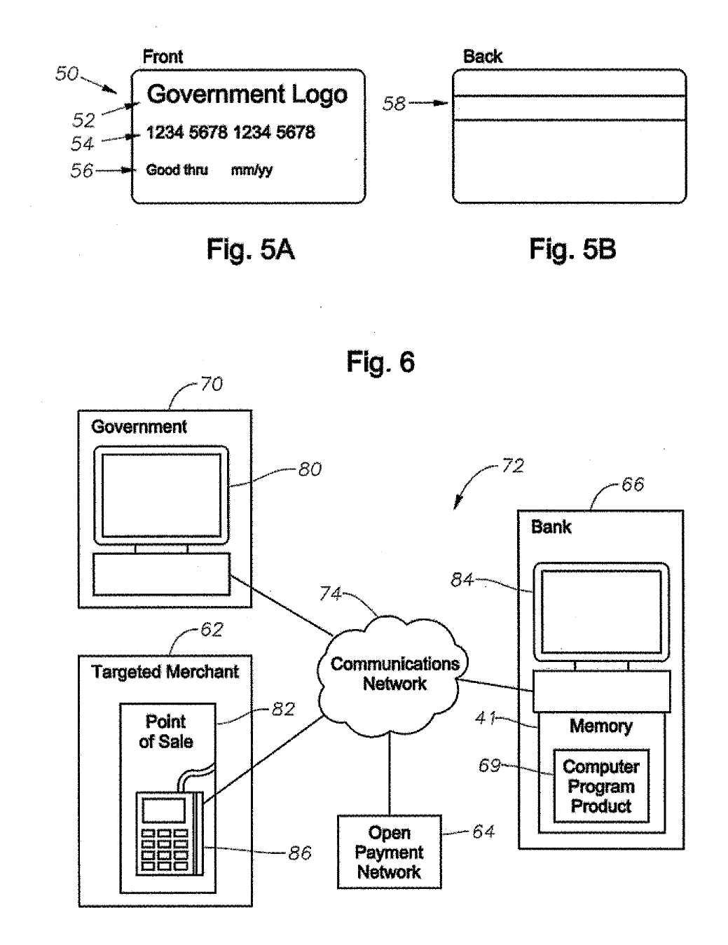

FIGS. 5A and 5B illustrate a government targeted-spending stimulus card 50, according to an embodiment of the present invention. As understood by those skilled in the art, the stimulus card can have indicia 52, e.g., logos, slogans, source identifiers, of the government; a serial number 54; and expiration date 56. The structures of various types of specific cards, e.g., magnetic stripe 58, type of material, are well known to those skilled in the art and can be used with embodiments of the present invention. Typically, a card 50 is formed from plastic and has a magnetic stripe 58 affixed to the plastic through an application of heat. Those skilled in the art will understand that other embodiments besides a magnetic stripe can include radio frequency identification devices (RFID), smart chips, bar codes, and other similar devices. Embodiments of the present invention can include forming cards or receiving cards already formed. In addition, the stimulus cards can have indicia of the open payment network 64. Because of the expiration date 56 on the stimulus card according to embodiments of the present invention, the government 70 can target the timeframe and duration of the targeted-spending stimulus program, perhaps saving billions in unnecessary spending. The effect of the expiration date 56 on a stimulus card 50 is to render the card void and incapable of further purchases of goods, services, or goods and services.

A magnetic stripe card 50 can store information, or data, e.g., account information, by modifying the magnetism of particles on the magnetic stripe 58 on the card. The information can be read by swiping the card past a reading head, including most point-of-sale hardware 82. See FIG. 6. Typically, there are two tracks of information on a magnetic card used for financial transactions, known as tracks 1 and 2. In addition, a third track, known as track 3, can be available for magnetic stripe cards. Tracks I and 3, if available, are typically recorded at 210 bits per inch, while track 2 typically has a recording density of 75 bits per inch. Track 2, as typically encoded, was developed by the American Bankers Association (ABA) provides for 37 numeric data characters, including up to 19 digits for a primary account number, an expiration date, a service code, and discretionary verification data, such as, a Personal Identification Number, or PIN. The information on the card can be used, for example, to facilitate a transaction. For example, when the card 50 is swiped through a reader 82, the information on the magnetic stripe 58 is read and processed by the reader 82. The reader can then communicate through an electronic communications network 74 to, for example, an open payment network 64, e.g., VISA, MasterCard, Discover, and American Express; the open payment network 64 can then communicate with the bank computer 84. The card reader, e.g., point of sale, communicates the account information as read from the card, as well as other information, such as, an amount of a proposed transaction for approval. The other information, for example, can be entered by merchant personnel (e.g., an amount of the transaction), the consumer (e.g., a PIN, or security code), or bank personnel (e.g., a security approval). The computer program product 69 executing on the bank computer 84 can then utilize the account information and other information to authorize or reject a purchase by, for example, determining whether a proposed purchase by the consumer is less than an amount of funds remaining for the stimulus card up to the pre-selected spending limit and whether the proposed consumer purchase is requested from one of the plurality of targeted merchants (block 26). The computer program product 69 can also reject a proposed transaction, or deny an authorization request, if, for example, the stimulus card has not been activated and thus is inactive by reading a field in an entry in a database 140 stored on the bank computer 84, where the entry is associated with the promotion card. The computer program product 69 can also reject a proposed transaction if the database 140 indicates that the expiration date 144 is past. Moreover, optional security measures, including, for example, a mismatch between a PIN supplied by the consumer and a PIN 143 stored in the database 140, can result in the rejection of a proposed transaction by the computer program product 69. Responsive to the determination, the computer program product 69 then perform certain functions, including responding to the authorization request so that the point-of-sale 82 displays an indication of approval or rejection, resulting in a visual depiction to the merchant of the approval or rejection of the proposed transaction. Also, the computer program product 69 can, for example, write data to a database 140 to record the transaction, write data to stored location in memory 41 of a bank computer 84, to debit available funds from an account associated with the stimulus card 50, and to credit directly or indirectly a merchant 62 for the purchase. In addition to purchase authorization, embodiments of the present invention also can include customer inquiries into recent transactions or a balance inquiry, i.e., an amount of remaining value associated with the stimulus card.

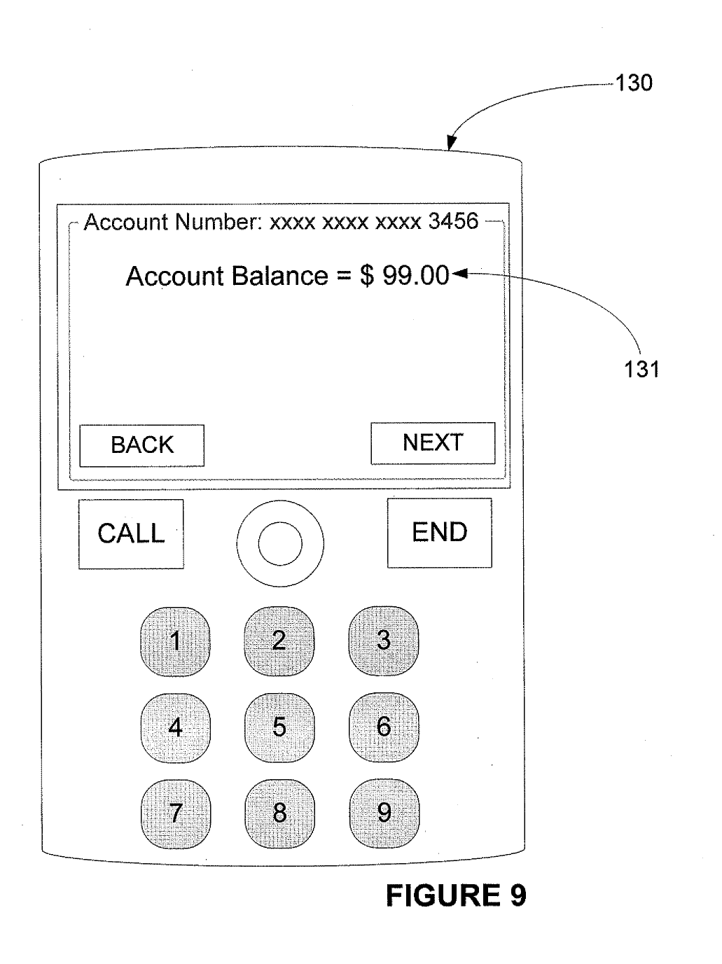

Embodiments of the present invention can also include, for example, various interface access devices. An interface access device can include, for example, a point of sale apparatus 82 at a merchant 62. An interface access device can also include, for example, a website that accepts the stimulus card serial number 54, or account number, either through a reader or through manual entry. The website can then display to the consumer, for example, a balance associated with the stimulus card or recent transactions. Embodiments of other interface access devices can further include, for example, a mobile phone or personal digital assistant (PDA) 130 for sending text messages 131. See FIG. 9. Embodiments can also include, for example, a telephone interface, including a computerized interactive voice response unit (IVRU). In another embodiment, a customer interface access computer can be, for example, an electronic kiosk computer positioned remote from the merchant point of sale 82 and remote from and in communication with the bank computer 84 via a communications network 74. The electronic kiosk computer, for example, can include a processor, a memory element, a display device, a user interface device, and a printer. According to exemplary embodiments of the present invention, the kiosk computer can be operated and controlled by a merchant 62 or a bank 66. The electronic kiosk computer can, for instance, transmit via the communications network 74 account information and a query to the bank computer 84 via a communications network 74. In embodiments of the present invention where an electronic kiosk computer is used, the response to the query can include, for example, displaying recent transaction data on a display device, or screen, of the kiosk computer. According to embodiments of the present invention, the electronic kiosk can be, for example, of similar construction and operation to kiosks used by airlines to purchase tickets and print boarding passes at an airport. Embodiments of various access devices can allow, for example, a consumer 60, a merchant 62, a bank 66, or a government 70 to interact with a display and/or user interface (e.g., keypad, keyboard) to perform certain additional operations, to store certain data, and make changes to data content associated with an account 68 or with a proposed transaction.

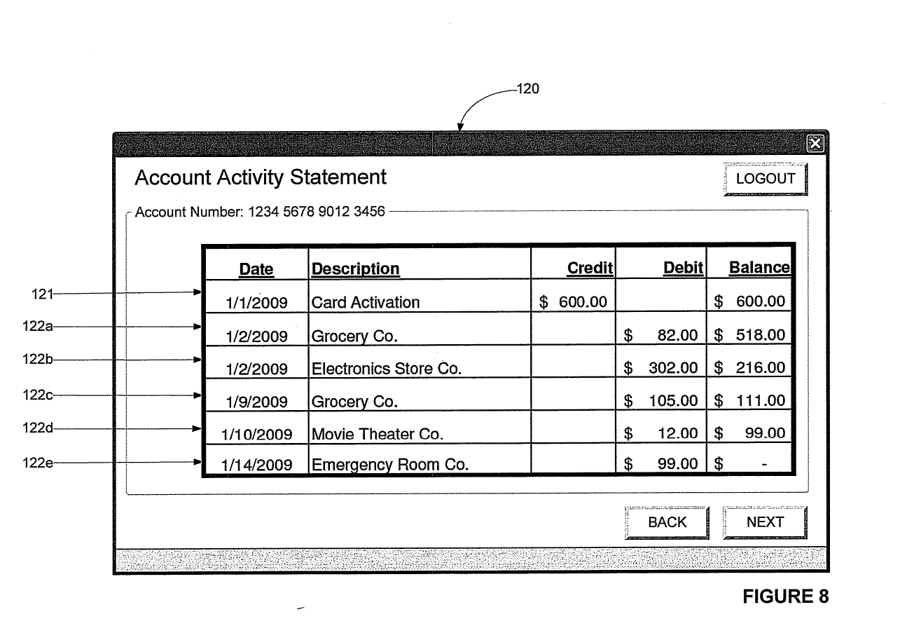

Embodiments of interface access devices advantageously provide a representation of account activity 120, including transactions 122a-122e in which value associated with a stimulus card is exchanged for goods, as illustrated in FIG. 8. In addition, a representation of account activity can include a representation of card activation 121. The visual depiction of a transaction can include a date and time of the transaction, an amount of the transaction, and merchant information, including name and address. Embodiments of interface access devices also advantageously provide a visual depiction of an amount of value associated with a stimulus card so that the amount of value can be exchanged for goods. Embodiments can include, for example, visual depictions and representations displayed on access interface devices to consumers, point-of-sale devices for merchants, and computer servers for bank personnel. In addition, embodiments can include, for example, printed representations, such as, a statement mailed to the consumer detailing transaction history and balance information, a consumer statement printed at a kiosk, or an electronic statement available as, for example, an e-mail or through a website, printed by the consumer. Embodiments can also include, for example, status reports and compilations for the bank managing the stimulus program, including transaction amounts and remaining balances.

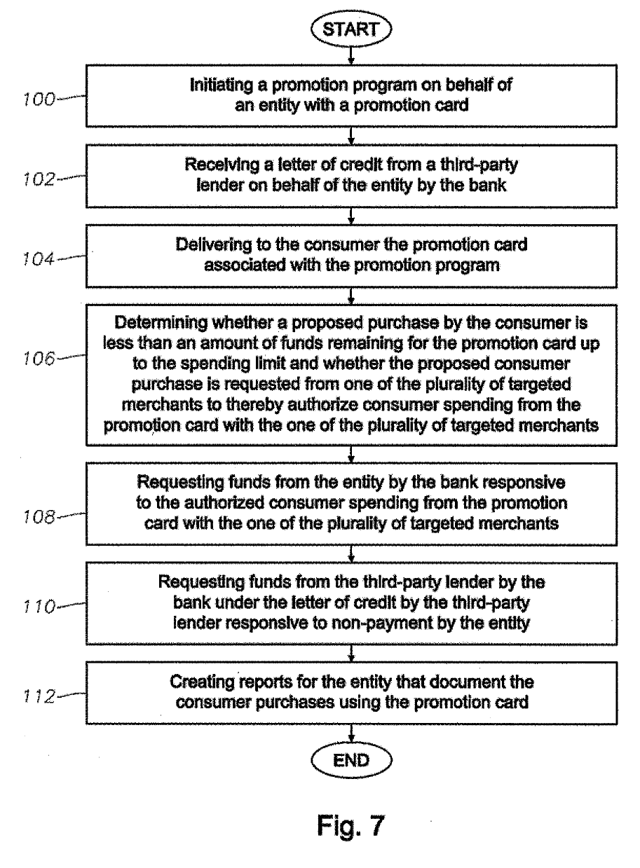

In addition, embodiments of the present invention include a computer-implemented method of funding a promotion card, as illustrated in FIG. 7. The computer-implemented method includes initiating a promotion program on behalf of an entity with a promotion card (block 100) by a bank computer. The program includes authorization of payments from entity funds on behalf of a consumer up to a spending limit, a selection of a plurality of targeted merchants as eligible to receive the payments on behalf of the consumer, and exclusion of cash payments on behalf of the consumer to thereby prevent the consumer access to cash under the program. According to embodiments of the present invention, the entity can be a government, a retailer, a manufacturer, a mall operator, or other such entity as understood by those skilled in the art. Also, according to embodiments of the present invention, the promotion card can involve a stimulus payment associated with a government targeted-spending stimulus program, a sales promotion, in-store credit, a rebate, and other such payments and promotions as understood by those skilled in the art. The computer-implemented method can further include receiving a letter of credit from a third-party lender on behalf of the entity by the bank (block 102). The computer-implemented method can continue with delivering to the consumer the promotion card (block 104) and activating the card by the bank computer. The bank computer can activate the promotion card by, for example, modifying a field in an entry in a database 140 stored on the bank computer 84, where the entry is associated with the promotion card. According to embodiments of the present invention, the promotion card 50 is from a bank, is subject to government banking laws and regulations, and is configured for authorization for a value up to the spending limit associated with the program. The computer-implemented method can also include a bank computer 84 determining whether a proposed purchase by the consumer 60 is less than an amount of funds remaining for the promotion card and whether the proposed consumer purchase is requested from one of the plurality of targeted merchants to thereby authorize consumer spending from the promotion card with the one of the plurality of targeted merchants (block 106). As understood by those skilled in the art, the selection of a plurality of targeted merchants as eligible to receive the payments on behalf of the consumer can include only targeted merchants affiliated with the entity, according to embodiments of the present invention. Therefore, according to embodiments of the present invention, a retailer can offer, for example, a promotion card with in-store credit redeemable only at other stores affiliated with the retailer, as understood by those skilled in the art. The computer-implemented method further includes requesting funds from the entity by the bank computer responsive to the authorized consumer spending from the promotion card with the one of the plurality of targeted merchants (block 108). The computer-implemented method can include requesting funds from the third-party lender by the bank computer under the letter of credit by the third-party lender responsive to non-payment by the entity (block 110). The method can include creating reports for the entity that document the consumer purchases using the promotion card (block 112).

According to embodiments of the present invention, the computer-implemented method can include a discount, so that the funds received from the entity into an account at the bank associated with the promotion card as payment for a consumer purchase include an amount of funds less than the amount of funds associated with the value of the card to a consumer to thereby define a discount. That is, the bank can sell a promotion card with a face value of $50 to a retailer or other entity for some amount less than $50, according to embodiments of the present invention.

According to embodiments of the present invention, the computer-implemented method can also include receiving funds on behalf the entity into an account at the bank associated with the promotion card as payment for the value remaining on the promotion card upon expiration via an ACH file, a wire transfer, or a combination, as understood by those skilled in the art. Automated Clearing House (ACH) is the name of an electronic network for financial transactions in the United States, regulated by the Federal Reserve, as understood by those skilled in the art.

This application claims priority to and the benefit of U.S. Provisional Patent Application No. 61/027,270, titled “Government Targeted-Spending Stimulus Card System, Program Product, and Associated Methods”, filed on Feb. 8, 2008, incorporated herein by reference in its entirety. This application also relates to: U.S. Provisional Patent Application No. 61/014,950, titled “Private Label Promotion Card System, Program Product, and Associated Methods”, filed on Dec. 19, 2007; U.S. patent application Ser. No. 12/338,497, by Galit, titled “Private Label Promotion Card System, Program Product, and Associated Computer-Implemented Methods”, filed Dec. 18, 2008; U.S. patent application Ser. No. 12/338,540, by Galit, titled “Private Label Promotion Card System, Program Product, and Associated Computer-Implemented Methods”, filed Dec. 18, 2008; each of which is incorporated herein by reference in its entirety.

Many modifications and other embodiments of the invention will come to the mind of one skilled in the art having the benefit of the teachings presented in the foregoing descriptions and the associated drawings. Therefore, it is to be understood that the invention is not to be limited to the illustrated embodiments disclosed, and that modifications and other embodiments are intended to be included within the scope of the appended claims.

That claimed is:

1. A system for funding a government targeted-spending stimulus card, the system comprising:
a first computer associated with a bank defining a bank computer, the bank computer having memory, being associated with an electronic communications network and in communication with an open payment network, and being positioned to manage an account associated with one or more government stimulus cards as part of a government targeted-spending stimulus program, the stimulus program including authorization of payments from government funds on behalf of a consumer up to a pre-selected spending limit, a selection of a plurality of targeted merchants as eligible to receive the payments on behalf of the consumer, and exclusion of cash payments on behalf of the consumer to thereby prevent the consumer access to cash under the government targeted-spending stimulus program; and
a computer program product associated with the bank computer, stored on a tangible computer memory media, and operable on a computer, the computer program product comprising a set of instructions that, when executed by the computer, cause the computer to perform the operations of:
initiating the targeted-spending stimulus program on behalf of a government with the government stimulus card by the bank computer,
activating the government targeted-spending stimulus card by the bank computer, the stimulus card being from a bank subject to government banking laws and regulations and being configured for authorization for a value of the pre-selected spending limit associated with the government targeted-spending stimulus program to thereby convert an inactivated card into an activated card having an associated value and being capable of purchasing goods,
determining by the bank computer whether a proposed purchase by the consumer is less than an amount of funds remaining for the government stimulus card up to the pre-selected spending limit and whether the proposed consumer purchase is requested from one of the plurality of targeted merchants to thereby authorize consumer targeted-spending from the government stimulus card with the one of the plurality of targeted merchants, and
requesting funds from a second computer associated with the government defining a government computer by the bank computer responsive to the authorized consumer spending from the stimulus card with the one of the plurality of targeted merchants, the funds being no more than the pre-selected spending limit to thereby fund the stimulus card.

2. A system of claim 1, further comprising a third computer associated with a third-party lender defining a third-party lender computer, the lender being positioned to provide a letter of credit to the bank on behalf of the government and the third-party lender computer being positioned to provide funds under the letter of credit responsive to non-payment by the government.

3. A system of claim 1, wherein the program product further performs the operation of creating reports for the government that document the consumer purchases using the government stimulus card so that the government targeted-spending stimulus program receives actual data on when and where the stimulus funds are spent, and wherein the reports include a plurality of visual depictions of consumer purchases as a function of location, as a function of time, and as a function of merchant category.

4. A system of claim 1, wherein the selection of the plurality of targeted merchants as eligible to receive the payments on behalf of the consumer comprises one or more predetermined categories of merchants for which economic targeted-spending stimulus is desired on behalf of the government to thereby influence consumer spending in and among these predetermined categories, and wherein the selection excludes other categories of merchants for which economic targeted-spending stimulus is not desired on behalf of the government to thereby narrowly focus the targeted-spending stimulus.

5. A system of claim 1, wherein the stimulus card has a predetermined expiration date to thereby render the card void and to thereby achieve the targeted-spending stimulus in the timeframe desired by the government.

6. A system of claim 1, wherein the program product further performs the operation of establishing a relationship with one or more of the plurality of targeted merchants to provide a discount for a consumer purchase using the stimulus card as payment so that the effect from government targeted-spending stimulus program on the economy is augmented.

7. A computer program product, stored on a tangible computer memory media, operable on a first computer associated with a bank defining a bank computer, used to fund a government targeted-spending stimulus card, the computer program product comprising a set of instructions that, when executed by the bank computer, cause the computer to perform the operations of:
initiating a targeted-spending stimulus program on behalf of a government with a targeted-spending stimulus card by the bank computer, the stimulus program including authorization of payments from government funds on behalf of a consumer up to a pre-selected spending limit, a selection of a plurality of targeted merchants as eligible to receive the payments on behalf of the consumer, and exclusion of cash payments on behalf of the consumer to thereby prevent the consumer access to cash under the government targeted-spending stimulus program;
activating the government targeted-spending stimulus card by the bank computer, the stimulus card being from a bank subject to government banking laws and regulations and being configured for authorization for a value of the pre-selected spending limit associated with the government targeted-spending stimulus program, to thereby convert an inactivated card into an activated card having an associated value and being capable of purchasing goods;
determining by the bank computer whether a proposed purchase by the consumer is less than an amount of funds remaining for the government stimulus card up to the pre-selected spending limit and whether the proposed consumer purchase is requested from one of the plurality of targeted merchants to thereby authorize consumer targeted-spending from the government stimulus card with the one of the plurality of targeted merchants; and
requesting funds from a second computer associated with the government defining a government computer by the bank computer responsive to the authorized consumer spending from the stimulus card with the one of the plurality of targeted merchants, the funds being no more than the pre-selected spending limit to thereby fund the stimulus card.

8. A computer program product of claim 7, wherein the program product further performs the operation of receiving funds from a third computer associated with a third-party lender defining a third-party lender computer under a letter of credit responsive to non-payment by the government.

9. A computer program product of claim 7, wherein the program product further performs the operation of creating reports for the government that document the consumer purchases using the government stimulus card so that the government targeted-spending stimulus program receives actual data on when and where the stimulus funds are spent, and wherein the reports include a plurality of visual depictions of consumer purchases as a function of location, as a function of time, and as a function of merchant category.

10. A computer program product of claim 7, wherein the selection of the plurality of targeted merchants as eligible to receive the payments on behalf of the consumer comprises one or more predetermined categories of merchants for which economic targeted-spending stimulus is desired on behalf of the government to thereby influence consumer spending in and among these predetermined categories, and wherein the selection excludes other categories of merchants for which economic targeted-spending stimulus is not desired on behalf of the government to thereby narrowly focus the targeted-spending stimulus.

11. A computer program product of claim 7, wherein the stimulus card has a predetermined expiration date to thereby render the card void and to thereby achieve the targeted-spending stimulus in the timeframe desired by the government.

12. A computer program product of claim 7 wherein the program product further performs the operation of establishing a relationship with one or more of the plurality of targeted merchants to provide a discount for a consumer purchase using the stimulus card as payment so that the effect from government targeted-spending stimulus program on the economy is augmented.

13. A computer-implemented method of funding a promotion card, the method comprising:
initiating a promotion program on behalf of an entity with a promotion card by a first computer associated with a bank defining a bank computer, the promotion program including authorization of payments from entity funds on behalf of a consumer up to a pre-selected spending limit, a selection of a plurality of targeted merchants as eligible to receive the payments on behalf of the consumer, and exclusion of cash payments on behalf of the consumer to thereby prevent the consumer access to cash under the promotion program;
activating the promotion card by the bank computer by modifying a field in an entry in a database stored on the bank computer, the entry associated with the promotion card, the promotion card being from a bank subject to government banking laws and regulations and being configured for authorization for a value of the pre-selected spending limit associated with the promotion program, to thereby convert an inactivated card into an activated card having an associated value and being capable of purchasing goods;
determining by the bank computer whether a proposed purchase by the consumer is less than an amount of funds remaining for the promotion card up to the pre-selected spending limit and whether the proposed consumer purchase is requested from one of the plurality of targeted merchants to thereby authorize consumer targeted-spending from the promotion card with the one of the plurality of targeted merchants; and
requesting funds from a second computer associated with the entity defining an entity computer by the bank computer responsive to the authorized consumer spending from the promotion card with the one of the plurality of targeted merchants, the funds being no more than the pre-selected spending limit to thereby fund the promotion card.

14. A computer-implemented method of claim 13, further comprising creating reports for the entity that document the consumer purchases using the promotion card so that the promotion program receives actual data on when and where the funds are spent, and wherein the reports include a plurality of visual depictions of consumer purchases as a function of location, as a function of time, and as a function of merchant category.

15. A computer-implemented method of claim 13, further comprising requesting funds from a third-party lender by the bank computer under the letter of credit responsive to non-payment by the entity.

16. A computer-implemented method of claim 13, wherein the entity is a government, wherein the promotion program is a government targeted-spending stimulus program, and wherein the promotion card is a government targeted-spending stimulus card.

17. A computer-implemented method of claim 16, wherein the selection of the plurality of targeted merchants as eligible to receive the payments on behalf of the consumer comprises one or more predetermined categories of merchants for which economic targeted-spending stimulus is desired on behalf of the government to thereby influence consumer spending in and among these predetermined categories, and wherein the selection excludes other categories of merchants for which economic targeted-spending stimulus is not desired on behalf of the government to thereby narrowly focus the targeted-spending stimulus.

18. A computer-implemented method of claim 16, wherein the stimulus card has a predetermined expiration date to thereby render the card void and to thereby achieve the targeted-spending stimulus in the timeframe desired by the government.

19. A computer-implemented method of claim 16, further comprising establishing a relationship with one or more of the plurality of targeted merchants to provide a discount for a consumer purchase using the stimulus card as payment so that the effect from government targeted-spending stimulus program on the economy is augmented.

20. A computer-implemented method of claim 16, wherein the step of activating the government targeted-spending stimulus card includes communications with an open payment network, wherein the bank is a federally-chartered bank, and wherein the step of initiating a government targeted-spending stimulus program on behalf of a government with a stimulus card includes managing a delivery of a plurality of stimulus cards to a plurality of consumers to thereby effect a stimulation of the economy, including purchases of goods and services.
